(19) United States
(12) Patent Application Publication
(10) Pub. No.: US 2009/0086742 A1
(43) Pub. Date: Apr. 2, 2009

(54) PROVIDING VIRTUAL SERVICES WITH AN ENTERPRISE ACCESS GATEWAY

(76) Inventors: Rajat GHAI, Sandwich, MA (US); John DEPIETRO, Sandwich, MA (US); Kaitki AGARWAL, Westford, MA (US); Thomas W. BONNER, Smyrna, GA (US); Vincent SPINELLI, Turnersville, NJ (US)

Correspondence Address: WILMERHALE/NEW YORK, 399 PARK AVENUE, NEW YORK, NY, 10022, US

(21) Appl. No.: 12/197,719

(22) Filed: Aug. 25, 2008

Related U.S. Application Data
(60) Provisional application No. 60/966,015, filed on Aug. 24, 2007.

(51) Int. Cl. H04L 12/66

(52) U.S. Cl. 370/401

(57) ABSTRACT

Systems and methods to virtually and securely extend voice, data, and video services as well as applications on communication networks is provided. An access gateway device is used to provide interworking and extension of services from an enterprise network or a hosted enterprise network to a public network such as an IP Multimedia Subsystem (IMS) network. The access gateway device can also enable handoffs between an enterprise access point and the service provider's radio network while maintain the user's session. The access gateway can also extend services from the enterprise network to the service providers network and vice versa.

### CROSS REFERENCE TO RELATED APPLICATION

This application claims benefit under 35 U.S.C. § 119(e) of U.S. Provisional Patent Application No. 60/966,015, entitled “Providing Virtual Services with an Enterprise Access Gateway,” filed Aug. 24, 2007, which is hereby incorporated by reference herein in its entirety.

### FIELD OF THE DISCLOSURE

This disclosure relates to a system and method for extending voice, data, and video services as well as applications virtually and securely within and between communication networks.

### BACKGROUND

Wireless communication systems and networks are used in connection with many applications, including, for example, satellite communications systems, portable digital assistants (PDAs), laptop computers, and cellular telephones. One significant benefit that users of such applications obtain is the ability to connect to a network (e.g., the Internet) as long as the user is within range of such a wireless communication system.

Current wireless communication systems use either, or a combination of, circuit switching and packet switching in order to provide mobile data services to a mobile node. A mobile node can be a cell phone, a PDA, a Blackberry, a laptop computer with a wireless card, or any other wireless device. Generally speaking, with circuit-based approaches, wireless data is carried by a dedicated (and uninterrupted) connection between the sender and recipient of data using a physical switching path. Once the direct connection is set-up, it is maintained for as long as the sender and receiver have data to exchange. The establishment of such a direct and dedicated switching path results in a fixed share of network resources being tied up until the connection is closed. When the physical connection between the sender and the receiver is no longer desired, it is torn-down and the network resources are allocated to other users as necessary.

Packet-based approaches, on the other hand, do not permanently assign transmission resources to a given call, and do not require the set-up and tear-down of physical connections between a sender and receiver of data. In general, a data flow in packet-based approaches is “packetized,” where the data is divided into separate segments of information, and each segment receives “header” information that may provide, for example, source information, destination information, information regarding the number of bits in the packet, priority information, and security information. The packets are then routed to a destination independently based on the header information. The data flow may include a number of packets or a single packet.

In some instances companies or organizations want to provide an internal network or an enterprise network. In the past an enterprise network was provided by a private branch exchange (PBX). A PBX is a telephone exchange that serves a particular business or organization, rather than that of a common carrier or telephone company that provides services for the general public. A PBX typically operates as a connection between a private organization and the public switched telephone network (PSTN). A reason for adopting a PBX in the circuit-switched days was to save money on internal phone calls within the organization because the switching was done within the organization. PBXs have, over time, also developed a number of services in addition to allowing for the internal calling efficiencies. The PBX has also evolved to be an IP PBX and to work over data connections. Organizations may also chose to have a PBX, but to outsource it to a service provider. Such PBXs are hosted by a service provider so an organization does not need to purchase the equipment and operate the equipment themselves.

### SUMMARY OF THE DISCLOSURE

Systems and methods for providing an access gateway to bridge a service provider's network and an enterprise network are provided. The access gateway allows a mobile node to roam from an enterprise network to a service provider's network without interruption and securely. The access gateway also extends services from the service provider's network to the enterprise network and services from the enterprise network to the service provider's network.

In some embodiments, a system providing interconnection between networks is provided including an enterprise access gateway (EAG) in operative communication with an enterprise network and a service provider's network, a database residing on a computer readable medium in operative communication with the EAG and wherein the database stores registration information of a mobile node including at least an enterprise network identity and a service provider network identity, and the EAG receiving a session request from a mobile node and providing a logical channel to the mobile node to maintain the session of the mobile node during a transition from the enterprise network to the service provider's network.

In certain embodiments, a method of providing network interworking is provided including receiving registration information including at least one identity for a mobile node, storing the registration information in a database, providing the registration information to an enterprise network and a service provider's network to register the mobile node with more than one network, and maintaining a session through a transition from a first network to a second network and from a first access technology to a second access technology.

### BRIEF DESCRIPTION OF THE DRAWINGS

FIG. 1 is a functional block illustration of an enterprise access gateway along with service provider's network and an enterprise network in accordance with certain embodiments;

FIG. 2A is a signaling diagram of a registration from an enterprise network to an IMS network in accordance with certain embodiments;

FIG. 2B is a signaling diagram of a call origination from an enterprise network to an IMS network in accordance with certain embodiments;

FIG. 3 is a functional block illustration of an enterprise access gateway providing interworking between multiple networks while maintaining a virtual private network in accordance with certain embodiments;

FIG. 4 is a functional block illustration of an enterprise access gateway providing interworking between various networks and handoffs in accordance with certain embodiments;

FIG. 5 is a functional block illustration of an enterprise access gateway providing interworking and extension of services between various networks in accordance with certain embodiments; and.

FIG. 6 is a function block illustration of a centrex architecture in accordance with certain embodiments.

### DETAILED DESCRIPTION

Systems and methods to virtually and securely extend voice, data, and video services as well as applications on communication networks is provided. In some embodiments, an access gateway device is used to provide interworking and extension of services from an enterprise network or a hosted enterprise network to a public network such as an IP Multimedia Subsystem (IMS) network. For example, a user can originate a call on company A's enterprise system and move seamlessly to telecom A's network without the call being dropped. Likewise, the user can benefit from services normally available on the enterprise network such as internal dialing or call transferring while receiving service from a public network, in certain embodiments.

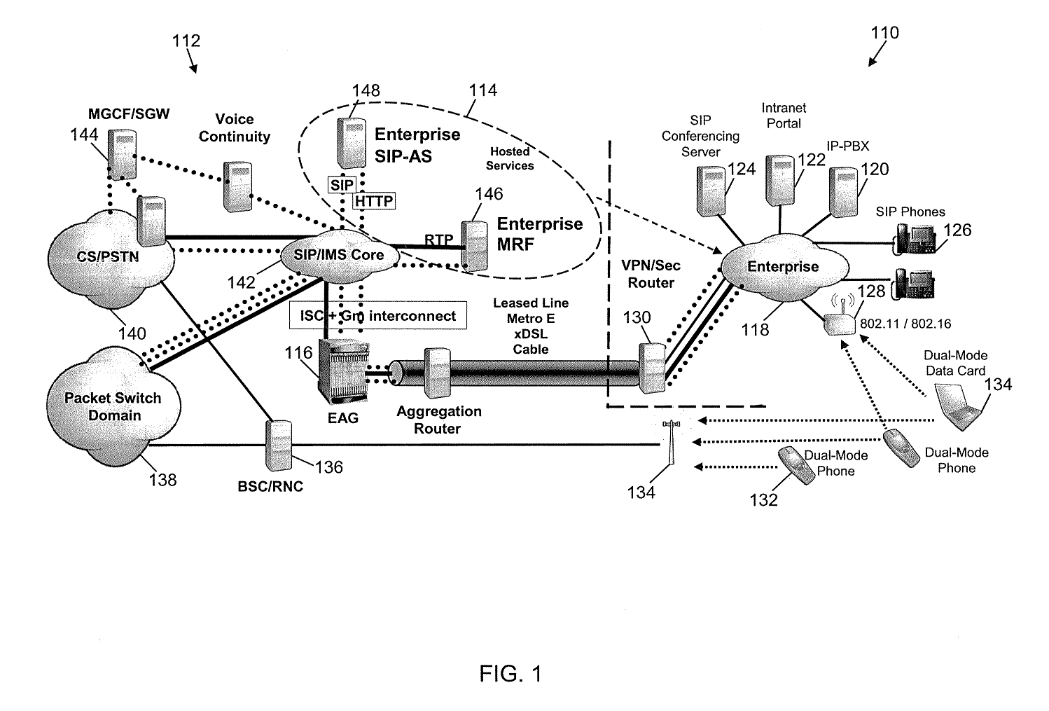

FIG. 1 illustrates an access gateway providing multi-protocol interworking between an enterprise network and a service provider's network in some embodiments. Enterprise network 110 provides an internal network for services such internal calling, an intranet, and wireless services such as WiFi (802.11). Enterprise network 110 can be in communication with a service provider's network 112 for such services as the internet and external phone calls. In certain embodiments, an enterprise network can be hosted by service provider 112. Such a situation is illustrated by hosted enterprise network 114. Although enterprise network 110 and hosted enterprise network 114 are setup in different ways, both can provide similar functionality and both can be used with an enterprise access gateway EAG 116. EAG 116 provides interworking functionality between the enterprise network 110 and the service provider's network 112. In a hosted enterprise network, EAG 116 can reside in the service provider's network 112 providing multi-protocol interworking with autonomous enterprise's customer premise equipment (CPE) to extend these services virtually. In enterprise network 110 (non-hosted), the EAG 116 can reside in an enterprise's network to provide extension of the enterprise services over the service provider's network 112.

Illustrated enterprise network 110 can include a network 118, a private branch exchange (PBX) 120, an intranet portal 122, a session initiation protocol (SIP) conferencing server 124, SIP phones 126, an access point (WiFi/WiMAX) 128, and a virtual private network (VPN)/security router 130. Network 118 can include routers, switches, and other equipment to distribute voice calls and/or data packets to phones, computers, and other office equipment. The PBX 120 provides various voice calling services as well as creating an internal exchange. In some embodiments, PBX 120 can provide services for fax machines, accounting purposes, and voicemail among others. PBX 120 can be an IP PBX that enables voice over IP (VoIP) calling. Intranet portal 122 can provide internal web services, network storage, email, and other packet data networking functions. SIP conferencing server 124 provides audio/video conferencing services. SIP phones 126 provide VoIP calling abilities, although other types of phones can also be used with enterprise network 110, such as circuit switched phones. Access point 128 can provide wireless mobile node access for dual mode phones and for other wireless devices. Access point 128 can utilize a number of access technologies such as WiFi (802.11), WiMAX (802.16), HIPERLAN, and 802.15.

The benefits of providing local wireless access through an enterprise network is that the mobile nodes 132 and 134 (e.g., a phone and a wireless laptop) can be provided intranet resources or receive a streaming conference. EAG 116 extends these benefits and others by allowing the mobile nodes to travel outside the enterprise network 110 and onto the service provider's network 112, and still maintain the streaming conference or link to the intranet resources. The EAG 116 can also extend the benefits of an IMS network 142 with its attendant services to enterprise network 118 such as delivering content from content providers or providing enterprise networks with the ability to accommodate secure data transmission and communication between remote workers, outsourced third-party vendors, and trusted partners.

The service provider's network can include a base station 134, a base station controller/radio network controller (BSC/RNC) 136, a packet switch domain 138, a circuit switched/public switched telephone network (CS/PSTN) 140, a SIP/IMS core 142, and a media gateway control function/security gateway (MGCF/SGW) 144. The hosted enterprise services 114 can include an enterprise media resource function (MRF) 146 and an enterprise SIP-AS (application server) 148. In some embodiments, enterprise MRF 146 and enterprise SIP-AS 148 can be used to provide hosted enterprise services to a directed set of equipment such as SIP phones 126, computers (not shown), or access points 128.

In certain embodiments, EAG 116 implements the interworking by storing multiple identities for the mobile node in a database. The storing of the identities of the mobile node can occur when the mobile node registers with a network to receive service. For example, when voice over IP (VoIP) service is used, the mobile node registers its IP address and port so incoming calls and the associated packets can be directed to the mobile node. In an IMS network, mobile node registration information can come in a SIP message. With a dual mode mobile node, the phone can have more than one identity, which allows use on more than one network. For example, an identity for the enterprise network and an identity for the service provider's network. In some embodiments, the dual mode mobile node uses an enterprise identity with an enterprise PBX to receive service on an enterprise network and a service provider identity with the service provider's network.

In certain embodiments, an EAG is used to register one or more identities at the same time. The EAG stores the multiple identities of a mobile node and correlates the information so that it can be used to interwork between the networks. The EAG can register on behalf of the mobile node with the service provider's network and the enterprise network. In some embodiments, the EAG registers with an IP PBX in the enterprise network and with a call session control function (CSCF) in the IMS core. The EAG database correlates mobile node's various identifiers, and the EAG can create a unique handle for identifying the user and correlate information stored in the database. The database can include information such as the address of record (AoR)/public user identity, private user identity (unique identification such as IMSI), contact information, registration expiration, registration status, service route header, authentication vector, subscriber profile, call restriction data, carrier identification, and IPsec parameters for security association.

When the mobile node is in some networks, the EAG may create a logical channel to the mobile node after the mobile node registers with the EAG. The logical channel provides extension of network capabilities even when the mobile node is another network that may not support those capabilities. For example, the logical channel allows a mobile node attached to an enterprise network with access to secure resources and other functions to transition to a service provider's network without the enterprise network realizing the mobile node has left the enterprise network. The logical channel can provide a secure conduit for extending service of one network onto another network. The logical channel can be also used to identify the location of the mobile node when a call originates in either a service provider's network or an enterprise network.

The logical channel can be created by appending the unique handle created by EAG to the headers of packets destined to the mobile node. The unique handle can be appended in a generic field such as the route header so that a mobile node places the unique handle on outbound packets (i.e., packets from the mobile node to the EAG). In some embodiments, the unique handle is used in IMS networks with SIP packets. The unique handle can be used to allow seamless transition from one network to another network, even when the enterprise network and the service provider's network are implemented with different protocols. The logical channel facilitates forwarding of the packets to the mobile node without interruption because when the mobile node crosses from the enterprise network to the service provider's network, the mobile node will already be registered with the other network and the logical channel can be used to maintain the illusion that the mobile node never left the enterprise network. In certain embodiments, a processor of the chassis on which the EAG functionality runs creates an object which creates a first call leg and creates a second object for a second call leg. The two call legs are joined within the chassis by the logical channel. The logical channel in this embodiment allows each object and the associated call leg to work within the parameters of the network with the logical channel bridging the two objects in the chassis.

A packet data gateway (PDG), a functionality that may be provided on the same chassis as the EAG, can create a secure tunnel which the logical channel can operate within. The secure tunnel and logical channel can be used to extend enterprise services over the service provider's network. Further, because the EAG is maintaining a database and has registered the mobile node with the respective networks, the user can seamlessly move between networks so conferences, emails, or other data flows are not interrupted by the mobile node's location.

In some embodiments, the PBX of the enterprise network may not be IMS aware, so the PBX may be unable to support the instructions or commands sent from the IMS network. In these embodiments, the EAG can provide interworking when an IMS client call is placed to a mobile node supported by a PBX. The EAG can provide interworking by employing a packet filter to pull packets with the unique handle or by the destination IP address and strip the SIP header or other packet header and append a header or instructions appropriate for the enterprise network. In the reverse direction, the EAG adds the headers for the service provider's network, if needed. In certain embodiments, when a call comes into the EAG, a database lookup is performed to determine how to route the call, and if the call needs to be routed to a PBX, the packet filtering and header conversion can be implemented.

Enterprise networks, in certain embodiments, may employ network address translation (NAT) firewalls so that devices behind the NAT firewall have a private IP address. The EAG can correlate the private and public IP addresses for the mobile node in the database and can change the private address to a public address for the service provider's network. The logical channel assists in providing service to mobile nodes behind a NAT firewall, or similar situations, by providing notification to the EAG to change the addressing information used by the various networks as the data packets pass through the EAG.

The EAG, in certain embodiments, supports charging for the services by using the unique handle created by the EAG for the call session. The unique handle is used by the backend billing systems such as the authentication, authorization, and accounting server (AAA) for tracking usage for charging purposes. In some embodiments, the backend systems do not need any modification. The backend systems use an ID, typically generated by the IMS core network, such as the CSCF, which can be instead generated by the EAG. This ID allows the backend billing systems to correlate the billing records generated by the EAG with those generated by the CSCF. The ID provides consistency when the mobile node, for example, moves between networks or switches between identities. This handle or ID can be dynamically assigned and is generated per registration and per call session.

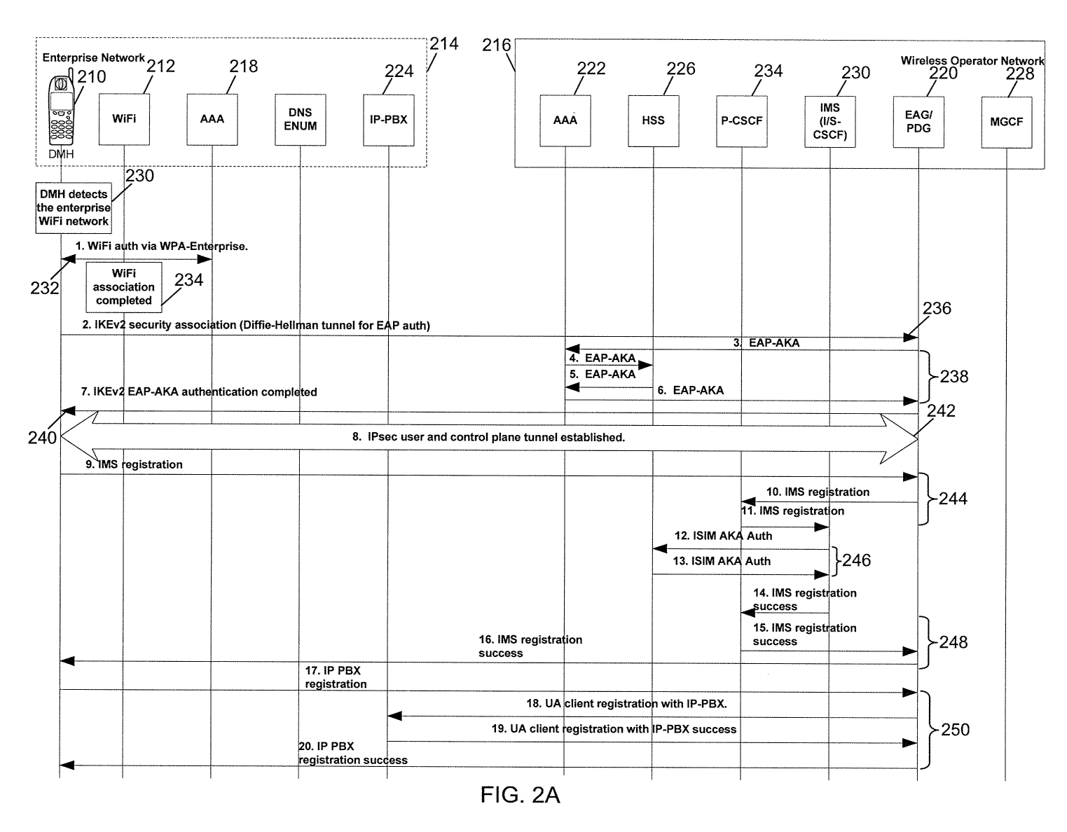

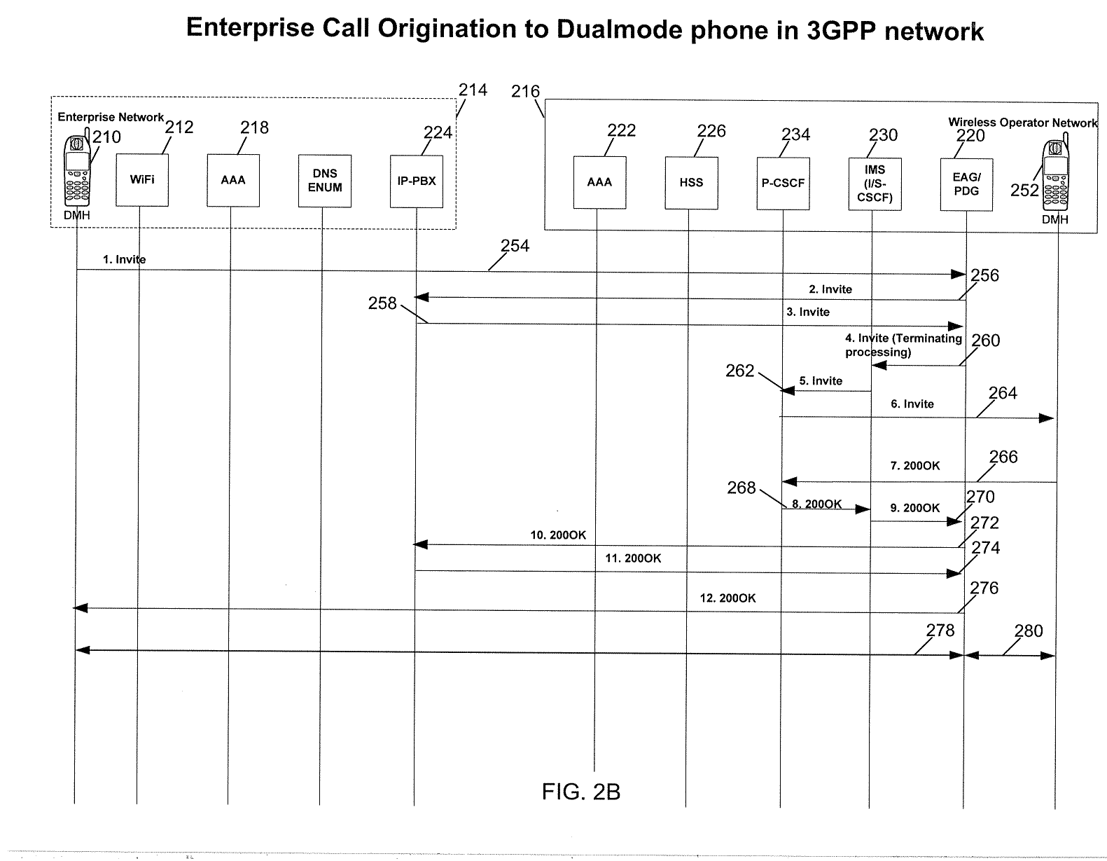

FIG. 2A illustrates signaling involved with registration of a mobile node calling from an enterprise network to a phone in a service provider's network in accordance with certain embodiments. FIG. 2A includes elements such as a dual mode mobile node 210, a WiFi access point, an enterprise network 214, a service provider's network 216, an authentication, authorization, and accounting (AAA) server 218, an EAG 220, an AAA server 222, an IP-PBX 224, a home subscriber server (HSS) 226, a media gateway control function (MGCF) 228, and a proxy-call session control function (P-CSCF) 234. In some embodiments, more than one element can be implemented on the same network device.

In 230, dual mode mobile node (DMH) 210 detects the enterprise WiFi network provided by WiFi access point 212. The DMH 210 authenticates with AAA 218 in 232 using, for example, WiFi protected access (WPA). In 234, the WiFi association is completed so the DMH 210 can access the network. In 236, an internet key exchange version 2 (IKEv2) security association is begun with EAG 220. A Diffie-Hellman cryptographic protocol can be used to setup a tunnel for performing extensible authentication protocol (EAP) authentication. In 238, EAP authentication and key agreement (AKA) occurs between EAG 220 and AAA 222 and HSS 226. The AAA 222 and HSS 226 can be used to authenticate information from DMH 210 to allow access to the service provider's network 216. When the authentication is completed, EAG 220 notifies DMH 210 with a message 240. An IP security (Ipsec) user and control plane tunnel is established between DMH 210 and EAG 220 in 242. DMH 210 begins IMS registration in 244. The EAG 220 contacts P-CSCF 234 and interrogating-call session control function (I-CSCF)/serving-call session control function (S-CSCF). In 246, IMS subscriber identity module (ISIM) authentication occurs between CSCF 230 and HSS 226. In 238, a successful IMS registration message is returned back to EAG 220 and DMH 210. In 250, internet protocol private branch exchange (IP PBX) registration occurs which involves the DMH 210, IP PBX 224, and EAG 220. The IP PBX registration allows use of the service provider's network through the IP PBX 224. In some embodiments, this allows DMH 210 to make voice calls over a WiFi air interface or use other resources of the service provider's network 216.

FIG. 2B illustrates signaling involved with calling from an enterprise network to a phone in a service provider's network in accordance with certain embodiments. Dual mode mobile nodes 210 and 252 both include multiple identities. One of which is for the enterprise network 214 and one of which is for the service provider's network 216. In certain embodiments, to begin a call session an invite message is sent to the devices involved in the call session and the devices respond with a 200 OK message. The invite message is used to carry information that includes information regarding the network device and the call session. An invite message 254 is sent to EAG 220 to begin the session. EAG 220 can include packet data gateway (PDG) or packet data interworking function (PDIF) to allow interworking or convergence between networks. EAG 220 sends an invite message 256 to IP PBX 224 and IP PBX 224 sends an invite message 258 to EAG 220. This invite exchange 256 and 258 can allow for the extension of services between dual mode mobile nodes 210 and 252. EAG 220 also sends an invite message 260 to an interrogating call session control function (I-CSCF) and/or serving call session control function (S-CSCF) 230. Invite message 260 can be used to contact dual mode mobile node 212 in the service provider's network 216, while informing CSCF 230 that EAG 220 will handle aspects of the call. CSCF 230 sends an invite message 262 to proxy call session control function (P-CSCF) 234 to carry out the call session setup. P-CSCF sends an invite message 264 to dual mode mobile node 212.

Dual mode mobile node 212 accepts the call session by sending a 200 OK message 266 to P-CSCF 234. P-CSCF 234 sends a 200 OK message 268 to CSCF 230, which sends a 200 OK message 270 to EAG 220. When EAG 220 receives 200 OK message 270, EAG 220 can complete the call session process with enterprise network 214 by sending 200 OK message 272 to IP PBX 224. IP PBX 224 sends a 200 OK message 274 to acknowledge that the call session can begin. Dual mode mobile node 210 is notified by EAG 220 with a 200 OK message 276. A logical channel 280 can then be setup between EAG 220 and dual mode mobile node 212. A logical channel 282 can also be setup between EAG 220 and dual mode mobile node 210.

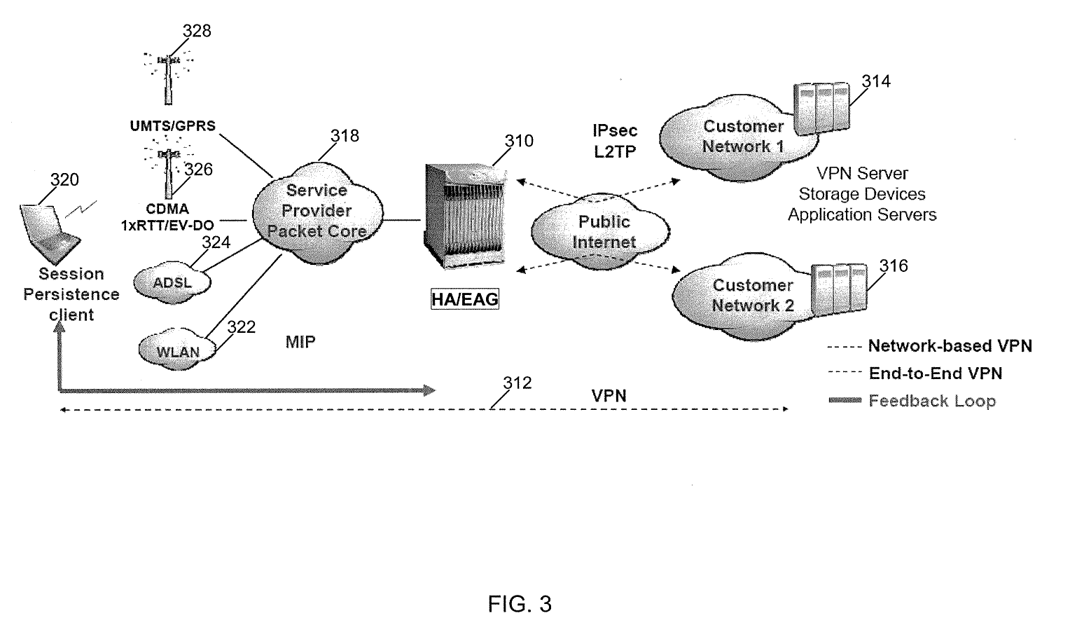

FIG. 3 illustrates session persistence across networks in accordance with certain embodiments. Illustrated home agent (HA)/EAG 310 provides session persistence such a virtual private network across networks and between networks. As shown, HA/EAG 310 provides an end to end VPN 312 between customer networks 314 and 316 and across a service provider packet core 318. VPN session 312 also persists when mobile node 320 moves from a wireless local area network (WLAN) 322 or an asymmetric digital subscriber line (ADSL) 324 to a code division multiple access (CDMA) 326 or universal mobile telecommunication system/general packet radio service (UMTS/GPRS) 328 for access service. Other wireless air interface technologies such as WiMAX can also be used with HA/EAG 310. HA/EAG 310 can also provide a fixed mobile convergence solution for service providers with wireline and wireless access networks. In some embodiments, the HA/EAG 310 serves as a mobile IP (MIP) anchor point that is integrated with a SIP proxy/registrar and a media server.

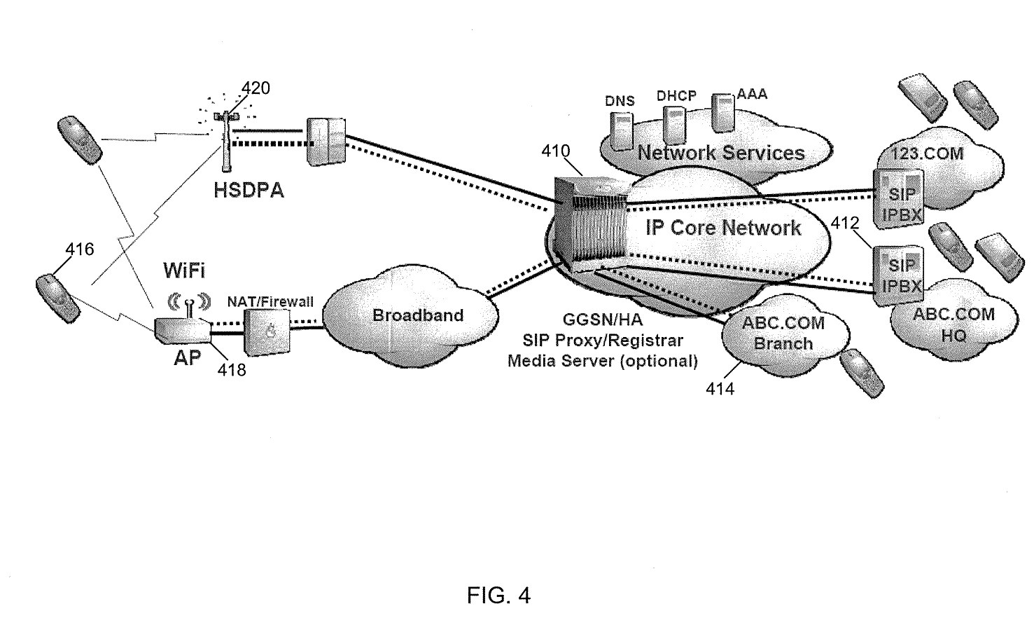

FIG. 4 illustrates various network systems including enterprise and service provider networks in accordance with certain embodiments. As noted above, an EAG 410 can be integrated with many other functionalities to provide seamless interworking of access technologies and extension of network services to other networks. An enterprise network can be formed by a SIP enabled IP PBX 412 and the enterprise network can be extended to other networks 414 through EAG 410. EAG 410 can also traverse network address translation and firewalls to provide service to a mobile node 416. Further, mobile node 416 can handoff from an access point 418 to a high-speed downlink packet access (HSDPA) 420 without losing the session or any services being virtually extended to mobile node 416. A handoff between the service provider's access network to the enterprise access network (e.g., WiFi access point) is supported by the EAG and the EAG can provide a transition from one network to the other network while maintaining the session. Since the session is maintained, the user of the mobile node does not need to re-register with the new network and capabilities of the former network can be maintained across to the new network. The EAG can provide for seamless voice handoffs where the customer on a call does not notice the handoff and the session is not interrupted as well as seamless data handoffs.

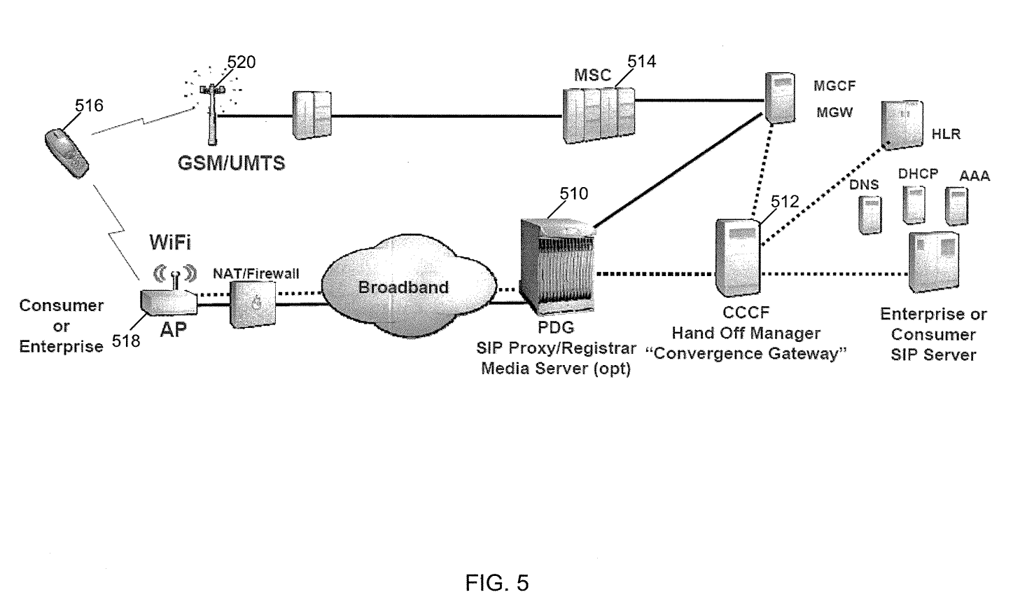

FIG. 5 illustrates providing interworking access between different networks including enterprise and service provider networks in accordance with certain embodiments. EAG 510 includes a PDG, a SIP Proxy/Registrar, and an option media server among other integrated functionalities. A call continuity control function (CCCF) resides in the IMS network and supports connects from circuit switched cellular to IMS, which could otherwise be controlled by a mobile switching center (MSC) 514. Further, a mobile node can maintain a session through a handoff between an enterprise or consumer access point 518 to a circuit switched service provider's global system for mobile communications/universal mobile telecommunications system (GSM/UMTS) 520 access technology.

Depending on the embodiment, a number of service model implementations exist for providing enterprise and service provider networks. In one embodiment, the enterprise network is service provider hosted (e.g., centrex). This embodiment targets smaller companies, for example, 500 employees or less. The service provider hosts the voice and data service (e.g., E.164 numbers, voice trunks, PSTN access, internet access, and dual mode service). The service provider can provide VoIP services to SIP desk and wireless phones in the enterprise network. The voice mail server can also reside in the service provider network. In another embodiment, the PBX and WiFi can be enterprise owned, while mobility and the media gateway are service provider hosted. In this embodiment, the service provider provides public E.164 numbers and access to the PSTN via SIP trunks. The service provider may provide the enterprise network with access to the internet or the enterprise network may use another internet service provider for this service. The voicemail server (VMS) can be located in the enterprise network. The mobility services provided by the service provider include dual mode service, converged consumer and enterprise supplementary services, and seamless and nomadic mobility between the service provider's network and the enterprise network. In yet another embodiment, the service provider manages mobility and the PBX/WiFi with the functions sitting in the enterprise network. In this embodiment the IP-PBX, the VMS, the WiFi, and the managed mobility function reside in the enterprise network. Other embodiments are also possible with different combinations of equipment and location of the equipment in the service provider's network and the enterprise network.

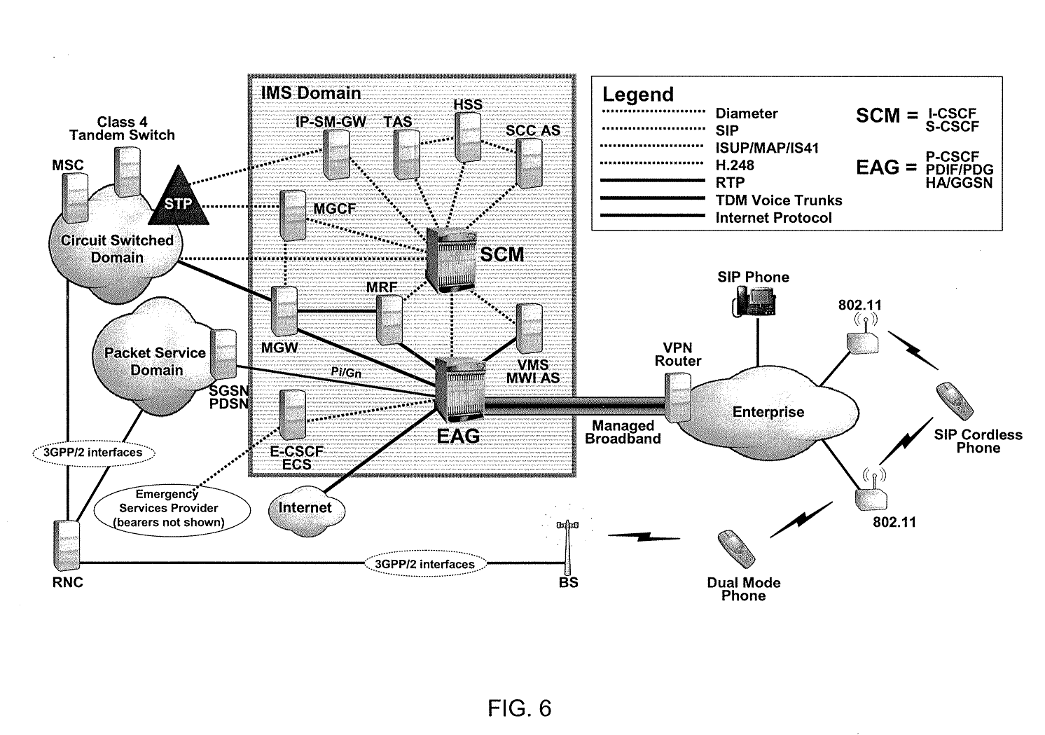

FIG. 6 illustrates an centrex architecture in accordance with certain embodiments. FIG. 6 includes network elements such as enterprise network 610, enterprise access gateway (EAG) 612, IMS network domain 614, voicemail server (VMS) message waiting indicator application server (MWI AS) 616, session control manager 618, SIP desk phone 620, a WiFi access point 622, a SIP cordless phone 624, a dual mode mobile node 626, a base station 628, a radio network controller 630, a packet service domain 632, a circuit switched domain 634, a SGSN/PDSN 636, internet 638, IP short message gateway (IP-SM-GW) 640, a telephony application server (TAS) 642, a home subscriber server (HSS) 644, a service centralization and continuity (SCC) application server (AS) 646, a media gateway control function (MGCF) 648, a media gateway (MGW), and a media resource function (MRF) 652.

SCM 618 can be implemented on a chassis as described below and can provide P-CSCF, I-CSCF, and S-CSCF functionality. The S-CSCF of SCM 618 acts as a user agent, interacts with application servers, event notifications, performs session control services for subscribers, and maintains session state for services provided to subscribers. The I-CSCF of SCM 618 provides registration, routes foreign SIP requests to the S-CSCF, translates E.164 numbers, obtains the S-CSCF address information from HSS 644, and generates call detail records (CDRs). The EAG 612 can be implemented on a chassis as described below and can provide P-CSCF, packet data interworking function (PDIF)/packet data gateway (PDG) functionality, and home agent (HA)/GPRS gateway support node (GGSN) functionality. The P-CSCF can provide a first entry point for mobile nodes, validate SIP messages, process emergency sessions, provide security, and provides signal compression (SIGCOMP). The PDIF/PDG enables WiFi and broadband IP access to the service provider's network (e.g., the cellular packet data network). The HA/GGSN provides a mobility anchor and a policy enforcement point for the service provider network. The VMS MWI AS 616 provides a unified messaging server that supports VoIP messaging and SIP MWI (e.g., subscribe and notify functions).

The IP-SM-GW 640 provides protocol conversion between SIP Message methods, short message service-gateway mobile switching center (SMS-GMSC), and short message service-interworking mobile switching center (SMS-IWMSC) to support short message service (SMS) over the IP connectivity access network (IP-CAN). The TAS 642 provides voice call/session and fixed mobile convergence (FMC) features. The HSS 644 provides a master subscriber database that includes service profiles, authentication and authorization, mobility data, and location information. SCC AS 648 is a IMS application that provides functionality used to enable IMS centralized services. These IMS centralized services can enable the use of IMS resources to a variety of devices such as SIP phone 620, SIP cordless phone 624, and dual mode phone 626, which may connect to the network using different protocols. The MGCF 648 provides protocol conversions for signaling traffic between packet and circuit switched networks and controls the media gateway bearer setup. The MGW 650 provides protocol conversions for bearer traffic between packet and circuit switched networks. The MRF 652 provides tones, announcements, and teleconferencing abilities.

The enterprise access gateway can provide a single common anchor node for enterprise and service provider based calls (e.g., cellular based calls). The EAG can also provide a single voice mailbox for calls made to a landline desk phone, a mobile node, and/or a cordless SIP phone. The EAG can also provide multiple ring service where multiple devices ring when a call is placed. The service can be simultaneous ring or a sequential ring process. The EAG can provide mobility between enterprise and cellular based networks. Multiple and different type of devices can be supported through the EAG such as single mode mobile node (e.g., a 3G UMTS mobile node), a dual mode mobile node (e.g., WiFi and 3G enabled device), a SIP desk phone, a SIP cordless phone, and computer telephony. The EAG can provide a user with use of conference calling, call hold, call waiting, transfers, caller ID, from either the service provider or enterprise networks. The user can maintain contiguous access to voice and data service and supporting applications across the enterprise network and public cellular networks.

The enterprise access gateway described above is implemented in a chassis in some embodiments. This chassis can implement multiple and different integrated functionalities. In some embodiments, an access gateway, a packet data serving node (PDSN), a foreign agent (FA), or home agent (HA) can be implemented on a chassis. Other types of functionalities can also be implemented on a chassis in other embodiments are a Gateway General packet radio service Service Node (GGSN), a serving GPRS support node (SGSN), a packet data inter-working function (PDIF), an access service network gateway (ASNGW), a base station, a access network, a User Plane Entity (UPE), an IP Gateway, an access gateway, a session initiation protocol (SIP) server, a proxy-call session control function (P-CSCF), and an interrogating-call session control function (I-CSCF). In certain embodiments, one or more of the above-mentioned other types of functionalities are integrated together or provided by the same functionality. For example, an access network can be integrated with a PDSN. A chassis can include a PDSN, a FA, a HA, a GGSN, a PDIF, an ASNGW, a UPE, an IP Gateway, an access gateway, a HSGW, or any other applicable access interface device. The gateway can also support sessions originated from a Femto base station, which would connect to the gateway using a broadband network. A person or corporation may use a Femto base station in a home or business to support one or more mobile nodes. The gateway can provide trigger based traffic management during a handoff from a Femto base station to a macro base station, while maintain traffic management for the mobile node. The Femto base station can reside in an enterprise network in some embodiments. In certain embodiments, a chassis is provided by Starent Networks, Corp. of Tewksbury, Mass. in a ST16 or a ST40 multimedia platform.

The features of a chassis that implements an enterprise access gateway, in accordance with some embodiments, are further described below. The chassis includes slots for loading application cards and line cards. A midplane can be used in the chassis to provide intra-chassis communications, power connections, and transport paths between the various installed cards. The midplane can include buses such as a switch fabric, a control bus, a system management bus, a redundancy bus, and a time division multiplex (TDM) bus. The switch fabric is an IP-based transport path for user data throughout the chassis implemented by establishing inter-card communications between application cards and line cards. The control bus interconnects the control and management processors within the chassis. The chassis management bus provides management of system functions such as supplying power, monitoring temperatures, board status, data path errors, card resets, and other failover features. The redundancy bus provides transportation of user data and redundancy links in the event of hardware failures. The TDM bus provides support for voice services on the system.

The chassis supports at least two types of application cards: a switch processor card and a packet accelerator card. The switch processor card serves as a controller of the chassis and is responsible for such things as initializing the chassis and loading software configurations onto other cards in the chassis. The packet accelerator card provides packet processing and forwarding capabilities. Each packet accelerator card is capable of supporting multiple contexts. Hardware engines can be deployed with the card to support parallel distributed processing for compression, classification traffic scheduling, forwarding, packet filtering, and statistics compilations.

The packet accelerator card performs packet-processing operations through the use of control processors and a network processing unit. The network processing unit determines packet processing requirements; receives and transmits user data frames to/from various physical interfaces; makes IP forwarding decisions; implements packet filtering, flow insertion, deletion, and modification; performs traffic management and traffic engineering; modifies/adds/strips packet headers; and manages line card ports and internal packet transportation. The control processors, also located on the packet accelerator card, provide packet-based user service processing. The line cards when loaded in the chassis provide input/output connectivity and can also provide redundancy connections as well.

The operating system software can be based on a Linux software kernel and run specific applications in the chassis such as monitoring tasks and providing protocol stacks. The software allows chassis resources to be allocated separately for control and data paths. For example, certain packet accelerator cards can be dedicated to performing routing or security control functions, while other packet accelerator cards are dedicated to processing user session traffic. As network requirements change, hardware resources can be dynamically deployed to meet the requirements in some embodiments. The system can be virtualized to support multiple logical instances of services, such as technology functions (e.g., a PDSN, ASNGW, PDIF, HA, GGSN, or IPSG).

The chassis' software can be divided into a series of tasks that perform specific functions. These tasks communicate with each other as needed to share control and data information throughout the chassis. A task is a software process that performs a specific function related to system control or session processing. Three types of tasks operate within the chassis in some embodiments: critical tasks, controller tasks, and manager tasks. The critical tasks control functions that relate to the chassis' ability to process calls such as chassis initialization, error detection, and recovery tasks. The controller tasks mask the distributed nature of the software from the user and perform tasks such as monitor the state of subordinate manager(s), provide for intra-manager communication within the same subsystem, and enable inter-subsystem communication by communicating with controller(s) belonging to other subsystems. The manager tasks can control system resources and maintain logical mappings between system resources.

Individual tasks that run on processors in the application cards can be divided into subsystems. A subsystem is a software element that either performs a specific task or is a culmination of multiple other tasks. A single subsystem can include critical tasks, controller tasks, and manager tasks. Some of the subsystems that can run on a chassis include a system initiation task subsystem, a high availability task subsystem, a recovery control task subsystem, a shared configuration task subsystem, a resource management subsystem, a virtual private network subsystem, a network processing unit subsystem, a card/slot/port subsystem, and a session subsystem.

The system initiation task subsystem is responsible for starting a set of initial tasks at system startup and providing individual tasks as needed. The high availability task subsystem works in conjunction with the recovery control task subsystem to maintain the operational state of the chassis by monitoring the various software and hardware components of the chassis. Recovery control task subsystem is responsible for executing a recovery action for failures that occur in the chassis and receives recovery actions from the high availability task subsystem. Shared configuration task subsystem provides the chassis with an ability to set, retrieve, and receive notification of chassis configuration parameter changes and is responsible for storing configuration data for the applications running within the chassis. Resource management subsystem is responsible for assigning resources (e.g., processor and memory capabilities) to tasks and for monitoring the task's use of the resources.

Virtual private network (VPN) subsystem manages the administrative and operational aspects of VPN-related entities in the chassis, which include creating separate VPN contexts, starting IP services within a VPN context, managing IP pools and subscriber IP addresses, and distributing the IP flow information within a VPN context. In some embodiments, within the chassis, IP operations are done within specific VPN contexts. The network processing unit subsystem is responsible for many of the functions listed above for the network processing unit. The card/slot/port subsystem is responsible for coordinating the events that occur relating to card activity such as discovery and configuration of ports on newly inserted cards and determining how line cards map to application cards. The session subsystem is responsible for processing and monitoring a mobile subscriber's data flows in some embodiments. Session processing tasks for mobile data communications include: A10/A11 termination for CDMA networks, GSM tunneling protocol termination for GPRS and/or UMTS networks, asynchronous PPP processing, packet filtering, packet scheduling, Difserv codepoint marking, statistics gathering, IP forwarding, and AAA services, for example. Responsibility for each of these items can be distributed across subordinate tasks (called managers) to provide for more efficient processing and greater redundancy. A separate session controller task serves as an integrated control node to regulate and monitor the managers and to communicate with the other active subsystem. The session subsystem also manages specialized user data processing such as payload transformation, filtering, statistics collection, policing, and scheduling.

In some embodiments, the software needed for implementing a process or a database includes a high level procedural or an object-orientated language such as C, C++, C#, Java, or Perl. The software may also be implemented in assembly language if desired. Packet processing implemented in a chassis can include any processing determined by the context. For example, packet processing may involve high-level data link control (HDLC) framing, header compression, and/or encryption. In certain embodiments, the software is stored on a storage medium or device such as read-only memory (ROM), programmable-read-only memory (PROM), electrically erasable programmable-read-only memory (EEPROM), flash memory, or a magnetic disk that is readable by a general or special purpose-processing unit to perform the processes described in this document.

Although the present invention has been described and illustrated in the foregoing exemplary embodiments, it is understood that the present disclosure has been made only by way of example, and that numerous changes in the details of implementation of the invention may be made without departing from the spirit and scope of the invention, which is limited only by the claims which follow.

We claim:

1. A system providing interconnection between networks comprising:
an enterprise access gateway (EAG) in operative communication with an enterprise network and a service provider's network;
a database residing on a computer readable medium in operative communication with the EAG and wherein the database stores registration information of a mobile node including at least an enterprise network identity and a service provider network identity; and
the EAG receiving a session request from a mobile node and providing a logical channel to the mobile node to maintain the session of the mobile node during a transition from the enterprise network to the service provider's network.

2. The system of claim 1, wherein the EAG assigns a unique handle for the registration information in the database.

3. The system of claim 1, further comprising a packet data gateway (PDG) that is in operative communication with the EAG and creates a secure tunnel which the logical channel operates within.

4. The system of claim 1, wherein the EAG receives packets from the IMS network and modifies the packet for sending to an enterprise network.

5. A method of providing network interworking comprising:
receiving registration information including at least one identity for a mobile node;
storing the registration information in a database;
providing the registration information to an enterprise network and a service provider's network to register the mobile node with more than one network; and
maintaining a session through a transition from a first network to a second network and from a first access technology to a second access technology.

6. The method of claim 5, further comprising:
assigning a unique handle to the registration information in the database; and
providing the unique handle to the service provider's authentication, authorization, and accounting (AAA) server.

7. The method of claim 5, further comprising creating a logical channel to the mobile node to extend services from the first network to the second network when the mobile node is receiving access from the second network.
